(19) United States
(12) Patent Application Publication
(10) Pub. No.: US 2024/0140705 A1
(43) Pub. Date: May 2, 2024

(54) MOBILE CUSTOMIZABLE INVENTORY MANAGEMENT APPARATUS

(71) Applicant: Caleb Kelly, Round Rock, TX (US)

(72) Inventor: Caleb Kelly, Round Rock, TX (US)

(21) Appl. No.: 17/978,618

(22) Filed: Nov. 1, 2022

(51) Int. Cl. B65G 1/04; B65G 1/137

(52) U.S. Cl. CPC B65G 1/0492; B65G 1/1373

(57) ABSTRACT

An inventory management apparatus that utilizes bins and/or dispensers as desired for enabling the rapid storage and dispensation of goods, products, and other articles. The apparatus is capable of being customized with additional platforms, bins, and dispensers for extra storage and/or dispenser-mounted bristles to prevent accidental spillage of smaller articles. The bristles are designed for further customization and may be mounted with traditional nuts and bolts, screws, or hook-and-loop fastener systems, among other mounting systems. In addition, the apparatus is mobile enough to be moved about a facility through human or machine-induced locomotion via casters to further facilitate storage and dispensation of goods, products, and other articles.

I, Caleb Kelly, a citizen of the United States residing at 1507 Lantern Light Drive, Round Rock, Texas 78681, have invented a new and useful “MOBILE CUSTOMIZABLE INVENTORY MANAGEMENT APPARATUS”.

### CROSS-REFERENCES TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING OR COMPUTER PROGRAM LISTING APPENDIX

Not applicable.

### BACKGROUND

This section provides background information related to the present disclosure which is not necessarily prior art.

Inventory management in commercial facilities, such as warehouses and storefronts, is a crucial aspect of any business that procures, sells, stores, and/or ships goods. Efficient inventory management helps to ensure correct product selection, delivery to consumers, and efficient use of facility space while reducing physical waste, supply costs, workplace mishaps, and shrinkage. As such, devices that can improve inventory management are of great interest to individuals and companies alike.

Depending on a number of factors, commercial entities utilize a variety of devices and methods for inventory management. Some entities implement inventory systems using multi-level rack-like fittings in their warehouses or stores on which products are placed, either directly on the rack surface or inside containers which are then placed on the rack surfaces. Humans or machines move the entities' products to and from the racks for sales, shipping, or movement to another location in the facility, but the fittings themselves do not move.

Some entities possess means to fully automate their inventory management process using conveyor belts, robots, and other sophisticated electronic and hydraulic machinery. These inventory management systems are incapable of being operated by a single person or without the aid of computers and require specialized training to utilize the necessary inventory equipment.

Still other commercial entities rely simply on temporary tables, boxes, or rooms to hold and store product prior to sale or shipment. Such inventory management systems require little upfront cost or training and are often the result of business necessity as opposed to a pre-planned inventory management system. However, this type of inventory management is considerably more disorganized than other inventory systems and can lead to loss of product and decreased supply chain efficiency, especially as business scaling increases.

What is lacking in the prior art is a mobile storage platform that requires little to no training to use, can be easily moved around a warehouse by a person or machine, provides for simple and efficient categorization of goods, affords ample storage and quick retrieval of goods, is customizable, and takes up a minimum amount of space in a facility.

### SUMMARY

The present disclosure relates generally to special fittings, furniture, or accessories for shops, storehouses, facilities, warehouses, and the like, and, more particularly, to inventory management apparatuses capable of being moved about a warehouse and capable of being customized as required for various uses within a warehouse, as well as the method for utilizing the apparatus. The apparatus has bins and dispensers useful for enabling the rapid storage and dispensation of goods, products, and other articles and is capable of being further customized with additional bins for extra storage and/or dispenser-mounted bristles to prevent accidental spillage of small articles. In addition, the apparatus can be moved about a facility through human or machine-induced locomotion via casters to further facilitate storage and dispensation of articles.

### BRIEF DESCRIPTION OF DRAWINGS

The drawings described herein are for illustrative purposes only of selected embodiments and not all possible implementations, and are not intended to limit the scope of the present disclosure.

FIG. 1 is a perspective view of one embodiment of the present disclosure with three bins, three dispensers, and an accessory bin.

FIG. 2 is a perspective view of a bin that may be utilized in one embodiment of the present disclosure.

FIG. 3 is a perspective view of a dispenser without a bristle port plate that may be utilized in one embodiment of the present disclosure.

FIG. 4 is a perspective view of a dispenser with a bristle port plate affixed thereto by means of nuts and bolts that may be utilized in one embodiment of the present disclosure. FIG. 4 includes a dotted line connecting two bold arrows, each pointing to the number “5”, which indicates the portion of a dispenser that is shown in the cross-section view of FIG. 5.

FIG. 5 is a cross-section perspective view of a dispenser with a bristle port plate affixed thereto by means of nuts and bolts that may be utilized in one embodiment of the present disclosure.

FIG. 6 is a fractional view of the bottommost portion of a dispenser showcasing one embodiment of the present disclosure wherein a hook-and-loop fastener system is utilized to affix a bristle port plate to a dispenser.

Corresponding reference numerals indicate corresponding parts throughout the several views of the drawings.

### DETAILED DESCRIPTION

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use the disclosure and do not delimit the scope of the disclosure. In some example embodiments, well-known processes, well-known device structures, and well-known technologies are not described in detail.

To facilitate the understanding of the embodiments described herein, several terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. The terminology herein is used to describe specific embodiments of the disclosure, but their usage does not delimit the disclosure, except as set forth in the claims.

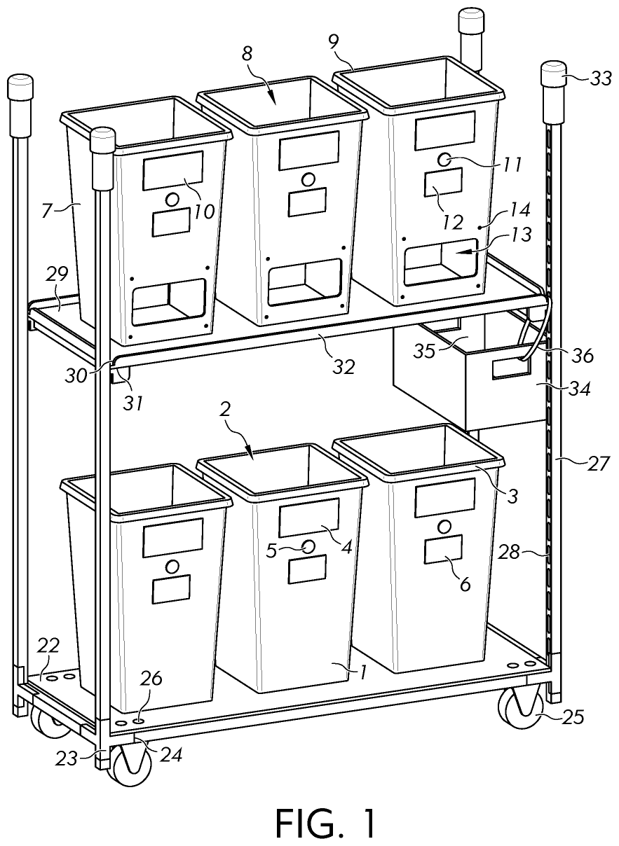

One embodiment of the present disclosure is illustrated in FIG. 1. In this embodiment, the disclosure has a rectangular base 22 with a substantially flat, horizontal surface and four posts 27 secured to the corners of the rectangular base 22. The posts 27 extend vertically upward from the base 22 and provide means for one or more rectangular platform tiers 29 to be attached at desired heights above the base 22. In this embodiment, one rectangular tier 29 is affixed to the posts 27 at a predetermined vertical distance from the base 22 and four rotatable casters 25 are affixed to the underside of the base 22 and contact the ground. Three storage bins 1 are placed on the upper side of the base 22, and three gravity-fed dispensers 7 are placed on the upper side of the elevated tier 29. One or more accessory bins 34 may be attached to any number of the posts 27 and/or tiers 29 as desired via a hook, strap, or other fastening device 36. A sleeve-cap 33 is placed over the top of each post 27 via an opening in one end of the sleeve-cap 33.

The base 22 can be made of a solid material of varying thickness or an interlocking or intermeshing material set upon, welded to, or bolted to a multi-sided frame of varying thickness sufficient to create a substantially horizontal, flat surface on which bins 1 or dispensers 7 can be placed without falling through the base 22. The surface of the base 22 can be any size or shape but is a rectangular shape in the embodiment shown in FIG. 1. The base 22 has a plurality of receiver pieces 23 spaced at a predetermined length along the edge of the base 22 into which the posts 27 are inserted. Each receiving piece 23 has means to secure a post 27 inserted inside such receiver piece 23. The base 22 has means for attaching 24 the receiver pieces 23, typically either by welding the receiver pieces 23 directly to the base 22 or by bolting the receiver pieces 23 to the base 22. In this embodiment, one receiver piece 23 is welded to each corner of the base 22.

A plurality of casters 25 is affixed to the underside of the base 22 and contact the ground. The caster 25 wheels rotate 360° and, in at least one embodiment, have brakes. The casters 25 have means to be affixed 26 to the underside of the base 22, typically either by welding and/or bolting the casters 25 to the base 22.

Each post 27 is inserted into a receiver piece 23 that is affixed to the base 22. Each post 27 has a substantially similar cross-section shape, but a slightly smaller cross-section size, than the hole of a receiver piece 23 so that the post 27 easily fits inside the receiver piece 23. Each post 27 can be any shape or size but is typically a rectangular prism that is 48 to 96 inches long by 1 to 4 inches wide by 1 to 4 inches in height. Each post 27 along its length has a plurality of means for receiving 28 a protrusion, hook, or other fastening piece 30-31 which, in this embodiment, emanates from or is otherwise attached to a tier 29.

If desired, one tier 29 or a plurality of tiers 29 can be affixed to the posts 27 as described in the immediately preceding paragraph. A tier 29 can be made of a solid material of varying thickness or an interlocking or intermeshing material set upon, welded to, or bolted to a multi-sided frame of varying thickness sufficient to create a substantially horizontal, flat surface on which the bins 1 and dispensers 7 can be placed without falling through such tier 29. The surface of a tier 29 can be any size or shape but is a rectangular shape in the embodiment shown in FIG. 1. A tier 29 has a plurality of protrusions, hooks, or other fastening pieces 30-31 spaced at a predetermined length along the edge of such tier 29 for use in securing such tier 29 to the posts 27. In this embodiment, one protrusion 30-31 at each corner of the rectangular tier 29 is inserted into a receiving slot 28 on a post 27 at the same position on each post 27 lengthwise as the other posts 27. Each tier 29 can have means for gripping 32 such tier 29 along one or more edges of such tier 29, such as via a lengthwise protrusion welded to the tier 29.

If desired, a sleeve-cap 33 with a cap on one end of such sleeve-cap 33 and an opening on the other end of such sleeve-cap 33 can be placed over the endpoint of one or more posts 27 such that the interior capped end of the sleeve-cap 33 rests on the top of a post 27 and the sleeve portion of the sleeve-cap 33 covers the topmost portion of such post 27. The sleeve-cap 33 lessens or prevents damage to the apparatus and any object which strikes or is struck by the apparatus.

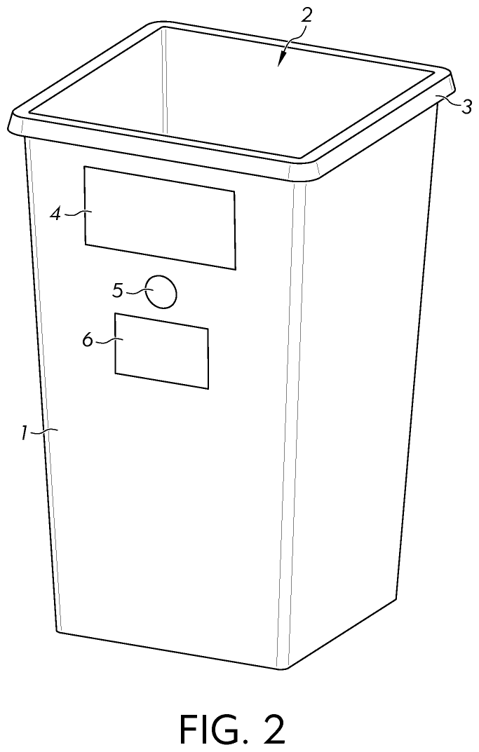

One or more bins 1 are situated on the base 22 and/or on one or more tiers 29, and/or affixed to the one or more posts 27 and/or one or more tiers 29 as desired. A bin 1 can be any three-dimensional shape with a cavity and an opening 2 for placing articles inside the bin 1 and a size capable of fitting on the apparatus base 22 or tiers 29. In the embodiment shown in FIG. 1, the bin 1 has a rectangular prism shape and an opening 2 on one side of the bin 1, with the side opposite the opening 2 in contact with the upper side of the base 22. A bin 1 can have means for gripping 3 said bin 1, such as a lip around the edge of the opening 2 of said bin 1 as shown in FIG. 2. One or more bins 1 can be labeled by directly marking or inscribing the bin(s) 1, or by affixing labels or other signifying material 4-6 to such bin(s) 1.

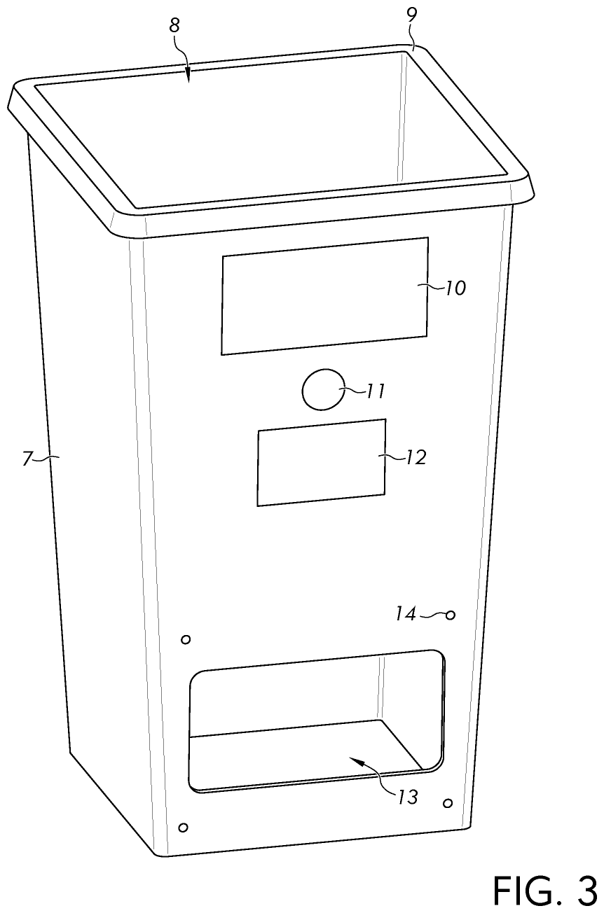

One or more dispensers 7 are situated on the base 22 and/or one or more tiers 29 as desired. A dispenser 7 can be any three-dimensional shape with a cavity, a first opening 8 for placing articles inside said dispenser, a dispensing opening 13 for removing articles from said dispenser 7, and a size capable of fitting on the apparatus base 22 or tiers 29. In the embodiment shown in FIG. 3, the dispenser 7 has a rectangular prism shape and a first opening 8 on one side of the dispenser 7, with the side opposite the first opening 8 in contact with the upper side of a tier 29 and a dispensing opening 13 on a side of the dispenser 7 perpendicular to the side with the first opening 8. A dispenser 7 can have means for gripping 9 such dispenser 7, such as a lip around the edge of the first opening 8 of the dispenser 7 as shown in FIG. 3. One or more dispensers 7 can be labeled by directly marking or inscribing the dispenser(s) 7, or by affixing a label or other signifying material 10-12 to such dispenser(s) 7.

One or more bristle set plates 15 can be affixed to a dispensing opening 13 on one or more dispensers 7 through which articles are removed. A bristle set plate 15 has at least one bristle set 16 and means of affixing 19 a bristle set 16 to such bristle set plate 15. The bristle set plate 15 is a flattened material small enough to fit within the bounds of the side of a dispenser 7 with a dispensing opening 13, but larger than the dispensing opening 13 to enable the bristle set plate 15 to be affixed to the dispenser 7 and not fall through the dispensing opening 13. The bristle set plate 15 has an opening in the middle of the flattened material and the bristle sets(s) 16 have means to be affixed 19 to the bristle set plate 15 along the edge of the opening of the bristle set plate 15. In one embodiment, a bristle set plate 15 has dimensions of about 13 inches long by 10 inches wide by ½ inch high, and a bristle set 16, including the means to affix 19 the bristle set 16 to the bristle set plate 15, has dimensions of about 11 inches long by 4 inches wide by 1 inch in height.

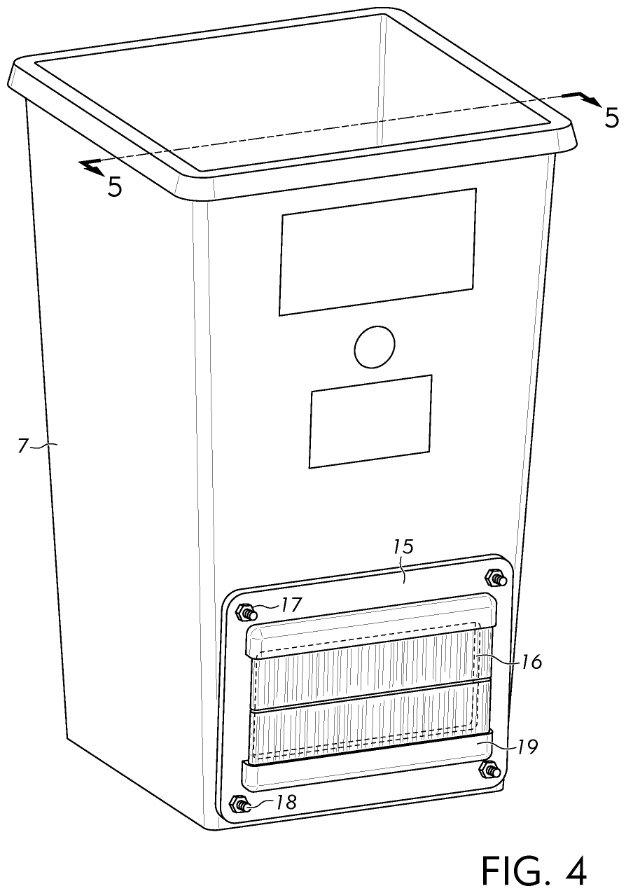

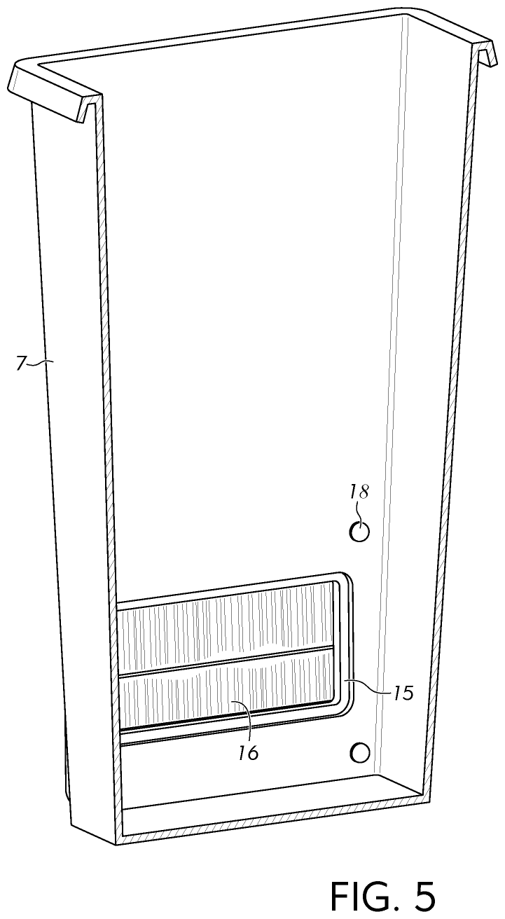

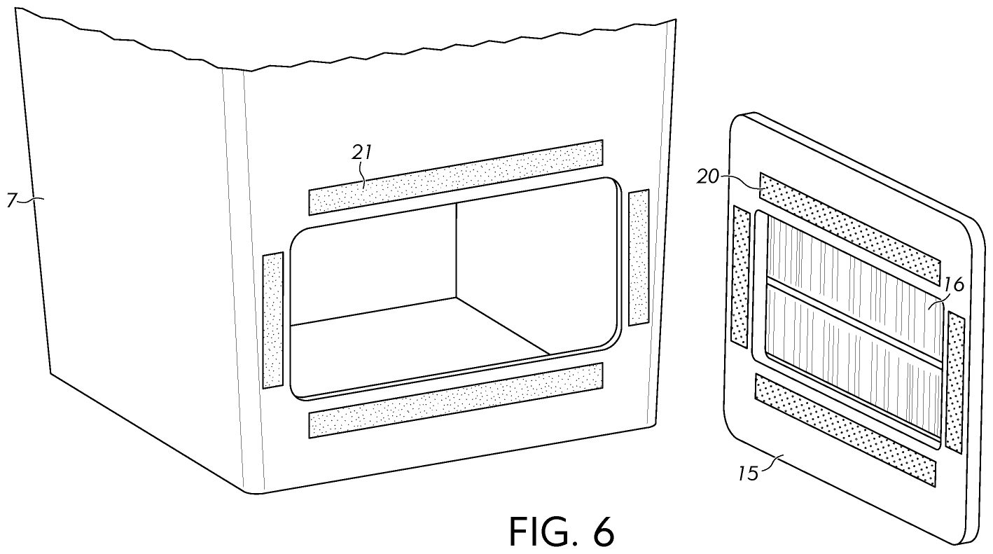

As shown in FIGS. 4-6, a bristle set 16 has means to be affixed 19 to a bristle set plate 15, which bristle set plate 15 has means to be affixed 14, 17-18, 20-21 over the dispensing opening 13 in a dispenser 7. In the embodiment shown in FIG. 4, two bristle sets 16 are affixed to the bristle set plate 15 by means of gluing the bristle sets 16 to the bristle set plate 15 such that the ends of each bristle set 16 (i.e., the “ends” being the part of the bristles that would contact the ground if the bristles were being used on a broom for sweeping debris) terminate in the substantially center portion of the bristle set plate 15 opening. Further, in the embodiment shown in FIG. 4, the bristle set plate 15 is affixed at pre-marked drill points with nuts 17 and bolts 18 to the exterior of the dispenser 7 such that the bristle sets 16 affixed to the bristle set plate 15 cover the dispensing opening 13. In one embodiment, rounded bolts 18 may be used to prevent articles from catching on the edge of the bolt as the articles are being removed from the dispenser 7. In another embodiment, shown in FIG. 6, a bristle set plate 15 may be affixed to a dispenser 7 by means of a hook-and-loop fastener system 20-21. In such embodiment, hook strips 20 are affixed to the side of a bristle set plate 15 opposite the side of the bristle set plate 15 to which bristle sets 16 are affixed, while loop strips 21 are affixed to the exterior of a dispenser 7 in such a manner as to line up with the hook strips 20 on the bristle set plate 15 when such bristle set plate 15 is placed over the dispensing opening 13.

In one embodiment, the base 22, tier 29, posts 27, and the portion of each caster 25 attached to the base 22 are made of steel, while the wheels attached to the metal casters 25, the sleeve-caps 33, the bins 1, the accessory bins 34, the dispensers 7, the bristle sets 16, and the bristle set plates 15 are made of a durable plastic. However, the base 22, tier 29, posts 27, and the portion of each caster 25 attached to the base 22 can be made of any desired material capable of providing rigidity to the present disclosure and supporting the weight of the present disclosure and the articles stored therein. Likewise, the bins 1, accessory bins 34, dispensers 7, bristle sets 16, and bristle set plates 15 can be made of any desired material capable of providing a rigid structure to contain articles but light enough to be able to be moved by a human. The wheels of each caster 25 can be made of any material capable of supporting the weight of the present disclosure and any articles contained therein. The sleeve-caps 33 can be made of any material light enough to be moved by a human but durable enough to prevent severe damage to the present disclosure. The means for affixing 36 the accessory bins 34 to the posts 27 and/or tiers 29 and the means for affixing 36 the casters 25 to the base 22 can be made of any material capable of securing such elements without breaking or deforming.

In one embodiment, the apparatus is operated for the purpose of categorizing and storing articles, moving those articles about a warehouse, and dispensing those articles at various locations around the warehouse or onto trucks for shipping. The apparatus in such embodiment has a rectangular prism shaped base 22 with dimensions of about 56 inches long by 22 inches wide by 2 inches high set on four 6-inch-tall casters 25 with the center of each caster 25 welded about 4 inches from each corner of the base 22. A receiver piece 23 is welded to each corner of the base 22 and oriented to receive a rectangular prism shaped post 27 with dimensions of about 74 inches long by 2 inches wide by 2 inches high such that each post 27 extends vertically from the receiver piece 23. A rectangular prism shaped tier 29 with dimensions of about 54 inches long by 20 inches wide by 1 inch high is affixed at each of such tier's 29 corners to the posts 27 at about 37 inches along the length of each post 27 measured from a receiver piece 23 of the base 22 such that the tier 29 sits slightly below chest height of a 6-foot human. Three bins 1 are placed on the base 22, three dispensers 7 are placed on the single tier 29, and a single accessory bin 34 is attached with zip ties to two of the posts 27 such that the accessory bin opening 35 is 6 inches below the tier 29 on one side of the apparatus. Each bin 1 and dispenser 7 has dimensions of about 13 to 16 inches long by 13 to 16 inches wide by 26 inches in height. Each dispenser's 7 dispensing opening 13 is about 10 inches long by 5 inches wide.

In one embodiment, articles such as shirts are separated by size and placed in the desired dispensers 7 and bins 1. Small shirts are placed in a first dispenser 7, medium shirts in a second dispenser 7, and large shirts in a third dispenser 7, all placed in each dispenser 7 either through the first opening 8 or dispensing opening 13 of each dispenser 7. Extra-large (XL) shirts are placed in a first bin 1, 2-XL shirts in a second bin 1, 3-XL in a third bin 1, and 4-XL shirts are placed in an accessory bin 34, all placed through the opening 2 in each bin 1 or accessory bin 34 opening 35 as applicable. The shirts remain stored in the dispensers 7 and bins 1 until either an order is placed by a customer or the shirts need to be moved elsewhere in the warehouse, at which point the appropriately sized shirt is selected from the appropriate dispenser 7 or bin 1 and moved elsewhere. Shirts are removed from the dispensers 7 through the dispensing opening 13 such that the first shirt placed in the first opening 8 of the dispenser 7 is the first shirt pulled from the dispensing opening 13. Shirts are removed from the bins 1 through the opening 2 such that the first shirt placed in the bin 1 is the last shirt pulled from the bin 1.

In another embodiment, a bristle set plate 15 is affixed over each dispenser's 7 dispensing opening 13, and the items placed inside each dispenser 7 being drink coolers, or “koozies”. Two bristle sets 16 are oriented on the bristle set plate 15 such that the ends of the bristle sets 16 face inward toward one another over the center of the dispensing opening 13. Koozies are typically much smaller items than shirts, so the bristle sets 16 serve to prevent the koozies from accidentally falling out of the dispensing opening 13 when the koozies are loaded through the first opening 8 in the top of a dispenser 7. Additionally, when a koozie is needed to be retrieved for movement to another location, a human will be able to reach his or her hand through the bristle sets 16 into the cavity of the dispenser 7 and remove such koozie without additional unselected koozies accidentally falling out of the dispenser 7, said unselected koozies being stopped from falling out of, or being removed along with, the desired koozie by the flexible yet firm bristle sets 16.

The apparatus has a multitude of advantages over the prior art, a few of which will be described below.

First, the apparatus is capable of being customized to fill a variety of warehouse roles. The bins 1, dispensers 7, and tiers 29 are all capable of being added to or removed from the apparatus as desired to enable greater storage capacity, faster dispensing of articles, or to make moving the apparatus easier, among other needs.

Second, the apparatus can be customized in an ergonomic fashion to limit physical strain on humans using the apparatus.

Third, the apparatus is mobile. This mobility enables a user to load the apparatus with articles, push and/or pull the apparatus to another section in a warehouse or to loading docks, and rotate the apparatus to the most ideal position for additional loading or dispensation of articles, or for storage of the apparatus itself.

Fourth, the size of the apparatus is customizable. All commercial facilities have some defined space within which product may be moved about, so commercial facility owners and workers try to avoid any wasted space or inefficient uses of the limited space. Therefore, it is desirable that an inventory management system be as small as possible but as useful as possible to make the best use of the limited space in the facility. The apparatus disclosed herein fulfills both of those desires.

Fifth, the apparatus is simple to use and customize.

The written description uses examples for disclosure and to enable any person skilled in the art to practice the disclosure, including making and using any materials or processes and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as a limitation of the disclosure. The principal features of this disclosure may be employed in various embodiments without departing from the spirit or scope of the disclosure. Those of ordinary skill in the art will recognize numerous equivalents to the specific procedures described herein. Such equivalents are considered to be within the scope of this disclosure and are covered by the claims.

Thus, although there have been described particular embodiments of the present disclosure of a new and useful MOBILE CUSTOMIZABLE INVENTORY MANAGEMENT APPARATUS, it is not intended that such references be construed as limitations upon the scope of this disclosure except as set forth in the claims.

What is claimed is:

1. A mobile inventory management apparatus comprising:
a. a storage platform of the type comprising a base surface;
b. at least one gravity-fed dispenser, situated on the storage platform, with means for placing articles inside the dispenser and an opening near the bottom of the dispenser whereby said articles may be removed from the dispenser;
c. at least one bin, situated on the storage platform, with means for placing articles inside the bin; and
d. a plurality of casters attached to the underside of the storage platform;
whereby articles can be placed in the bin(s) and/or dispenser(s) as desired to aid in categorization and storage of the articles;
whereby the storage platform can be moved about an area if desired; and
whereby the articles can be retrieved from the bin(s) and/or dispenser(s) for movement elsewhere.

2. The apparatus of claim 1, wherein a bristle set plate with at least one bristle set is affixed to the opening of at least one gravity-fed dispenser.

3. The apparatus of claim 1, wherein a plurality of gravity-fed dispensers is situated on the storage platform.

4. The apparatus of claim 1, wherein a plurality of bins is situated on the storage platform.

5. The apparatus of claim 1, wherein at least one accessory bin is attached to the side of the storage platform.

6. The apparatus of claim 1, wherein at least one tier is affixed to the storage platform and each tier is arranged vertically at a predetermined distance from the base surface.

7. The apparatus of claim 3, wherein a bristle set plate with at least one bristle set is affixed to the opening of at least one of the gravity-fed dispensers.

8. The apparatus of claim 6, wherein at least one gravity-fed dispenser is situated on a tier.

9. The apparatus of claim 6, wherein at least one bin is situated on the base surface.

10. The apparatus of claim 6, wherein at least one bin is attached to the side of the storage platform.

11. The apparatus of claim 6, wherein at least one bin is situated on the base surface and at least one gravity-fed dispenser is situated on a tier.

12. The apparatus of claim 6, wherein a plurality of bins is situated on the base surface and a plurality of gravity-fed dispensers is situated on a tier.

13. The apparatus of claim 6, wherein a plurality of bins is situated on the base surface and a plurality of gravity-fed dispensers is situated on a tier and at least one accessory bin is attached to the side of the storage platform.

14. The apparatus of claim 6, wherein a plurality of bins is situated on the base surface and a plurality of gravity-fed dispensers is situated on a tier and at least one accessory bin is attached to the side of the storage platform and a bristle set plate with at least one bristle set is affixed to the opening of at least one gravity-fed dispenser.

15. A method of managing inventory comprising:
a. providing a storage platform of the type comprising a base surface on which bins and/or gravity-fed dispensers can be placed, a plurality of posts for the addition of tiers as desired, and a plurality of rotatable casters for moving the storage platform about an area, if desired;
b. placing at least one gravity-fed dispenser on the platform for storage and retrieval of articles;
c. placing at least one bin on the platform for storage and retrieval of articles;
d. categorizing articles;
e. placing the categorized articles in the bin(s) and/or dispenser(s) for storage prior to moving the storage platform and/or retrieving the categorized articles;
f. moving the storage platform, if desired; and
g. retrieving the categorized articles from the bins(s) and/or dispenser(s) for movement to other locations.

16. The method of claim 15, wherein at least one tier is affixed to the posts of the storage platform.

17. The method of claim 15, wherein a bristle set plate with at least one bristle set is affixed to at least one dispenser.

18. The method of claim 16, wherein at least one bin is situated on the base surface and at least one dispenser is situated on a tier.

19. The method of claim 18, wherein a bristle set plate with at least one bristle set is affixed to at least one dispenser.

20. The method of claim 19, wherein at least one accessory bin is attached to the side of the storage platform.
